(19) United States
(12) Patent Application Publication
(10) Pub. No.: US 2026/0113494 A1
(43) Pub. Date: Apr. 23, 2026

(54) TEXT CONTENT GENERATION METHOD AND APPARATUS, MEDIUM, ELECTRONIC DEVICE AND PROGRAM PRODUCT

(71) Applicant: Beijing Volcano Engine Technology Co., Ltd., Beijing (CN)

(72) Inventors: Minglu Gao, Beijing (CN); Peng Sun, Beijing (CN); Zhuo Li, Beijing (CN); Xin Chen, Beijing (CN); Hongtao Ge, Beijing (CN); Chengcheng Yang, Beijing (CN); Macheng Yu, Beijing (CN); Huijun Qin, Beijing (CN); Si Fan, Beijing (CN)

(21) Appl. No.: 19/360,782

(22) Filed: Oct. 16, 2025

(30) Foreign Application Priority Data
Oct. 17, 2024 (CN) 202411456874.8

(51) Int. Cl. H04N 21/235; H04N 21/2187; H04N 21/81

(52) U.S. Cl. CPC H04N 21/2353; H04N 21/2187; H04N 21/812

(57) ABSTRACT

A text content generation method and apparatus, a medium, an electronic device, and a program product are provided. The method includes: displaying an information configuration interface, the information configuration interface being configured to configure attribute values of preset attribute fields of a to-be-recommended object; and generating target text content in response to a triggered generation operation based on the attribute values configured in the information configuration interface, the target text content being used for live streaming, the target text content including a tag field and text content corresponding to the tag field, the tag field being used to characterize a content structure of the target text content.

### CROSS-REFERENCE TO RELATED APPLICATION

The present application claims the priority of Chinese Patent Application No. 202411456874.8 field on Oct. 17, 2024, the disclosure of which is incorporated herein by reference in its entirety as a part of the present application.

### TECHNICAL FIELD

The present disclosure relates to the field of live streaming technology, and in particular, to a text content generation method and apparatus, a medium, an electronic device, and a program product.

### BACKGROUND

With the rapid growth of streaming media technology, live streaming services are becoming increasingly popular, and live streaming platforms have become one of the most popular media at present. Generally, in order to improve a live streaming effect, before a user starts live streaming, simulation practice of live streaming may be performed based on text content for live streaming which is provided in advance.

In the related art, a model may be used to automatically generate the text content for live streaming for the user. The quality of the text content is one of important factors affecting the live streaming effect. Therefore, how to improve the quality of the text content is of vital importance.

### SUMMARY

This Summary is provided to introduce concepts, in a simplified form, that are described in detail in the following Detailed Description section. This Summary is not intended to identify key features or essential features of the claimed technical solutions, nor is it intended to be used to limit the scope of the claimed technical solutions.

In a first aspect, the present disclosure provides a text content generation method. The method includes:
displaying an information configuration interface, where the information configuration interface is configured to configure an attribute value of a preset attribute field of a to-be-recommended object; and
generating, in response to a triggered generation operation, target text content based on the attribute value configured in the information configuration interface, where the target text content is used for live streaming, and the target text content includes a tag field and text content corresponding to the tag field, where the tag field is used to characterize a content structure of the target text content.

In a second aspect, the present disclosure provides a text content generation apparatus. The apparatus includes:
a first display module, configured to display an information configuration interface, where the information configuration interface is configured to configure an attribute value of a preset attribute field of a to-be-recommended object; and
a first generation module, configured to generate, in response to a triggered generation operation, target text content based on the attribute value configured in the information configuration interface, where the target text content is used for live streaming, and the target text content includes a tag field and text content corresponding to the tag field, where the tag field is used to characterize a content structure of the target text content.

In a third aspect, the present disclosure provides a computer-readable medium having a computer program stored thereon, where the computer program, when executed by a processing apparatus, performs the steps of the method according to the first aspect.

In a fourth aspect, the present disclosure provides an electronic device. The electronic device includes:
a storage apparatus, having a computer program stored thereon; and
a processing apparatus, configured to execute the computer program in the storage apparatus to perform the steps of the method according to any one of the first aspect.

In a fifth aspect, the present disclosure provides a computer program product including a computer program, where the computer program, when executed by a processor, performs the steps of the method according to the first aspect.

Other features and advantages of the present disclosure will be described in detail in the following detailed description section.

### BRIEF DESCRIPTION OF DRAWINGS

The above and other features, advantages, and aspects of various embodiments of the present disclosure become more apparent when taken in conjunction with the drawings and with reference to the following detailed description. Throughout the drawings, the same or similar reference numerals refer to the same or similar elements. It should be understood that the drawings are schematic and that parts and elements are not necessarily drawn to scale. In the drawings:

FIG. 1 is a flowchart of a text content generation method according to an exemplary embodiment of the present disclosure.

FIG. 2a is a schematic diagram of a first information configuration interface according to an exemplary embodiment of the present disclosure.

FIG. 2b is another schematic diagram of the first information configuration interface according to an exemplary embodiment of the present disclosure.

FIG. 3a is a schematic diagram of a second information configuration interface according to an exemplary embodiment of the present disclosure.

FIG. 3b is a diagram of an interface after attribute values of corresponding preset attribute fields are configured based on an input operation.

FIG. 4 is a schematic diagram of an interface of a display interface and an information configuration interface according to an exemplary embodiment of the present disclosure.

FIG. 5 is a schematic diagram of a practice interface according to an exemplary embodiment of the present disclosure.

FIG. 6 is a schematic diagram of an interface of an analysis report displayed according to an exemplary embodiment of the present disclosure.

FIG. 7 is a block diagram of a text content generation apparatus according to an exemplary embodiment of the present disclosure.

FIG. 8 is a schematic structural diagram of an electronic device according to an exemplary embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the scope of protection of the present disclosure.

It should be understood that the various steps described in the method implementations of the present disclosure may be performed in a different order and/or in parallel. In addition, the method implementations may include additional steps and/or omit performing the illustrated steps. The scope of the present disclosure is not limited in this respect.

The term “include/comprise” and its variants as used herein are open-ended inclusions, that is, “include/comprise but not limited to”. The term “based on” is “based at least in part on”. The term “one embodiment” means “at least one embodiment”, the term “another embodiment” means “at least one additional embodiment”, and the term “some embodiments” means “at least some embodiments”. Relevant definitions of other terms will be given in the following description.

It should be noted that concepts such as “first” and “second” mentioned in the present disclosure are only used to distinguish between different apparatuses, modules or units, and are not used to limit the order or interdependence of functions performed by these apparatuses, modules or units.

It should be noted that the modifiers of “one” and “a plurality of” mentioned in the present disclosure are illustrative rather than restrictive, and those skilled in the art should understand that unless the context clearly indicates otherwise, they should be understood as “one or more”.

The names of messages or information exchanged between a plurality of apparatuses in the implementations of the present disclosure are only used for illustrative purposes, and are not intended to limit the scope of these messages or information.

It should be understood that before using the technical solutions disclosed in the embodiments of the present disclosure, the user should be informed of the type, use range, use scenario, etc. of the personal information involved in the present disclosure through an appropriate manner, and the authorization of the user should be acquired in accordance with relevant laws and regulations.

For example, in response to receiving an active request from the user, prompt information is sent to the user to explicitly prompt the user that the operation requested to be performed will need to acquire and use the personal information of the user. Therefore, the user can independently select whether to provide personal information to software or hardware such as an electronic device, an application, a server, or a storage medium that performs the operations of the technical solutions of the present disclosure according to the prompt information.

As an optional but not limiting implementation, a manner of sending prompt information to the user in response to receiving the active request of the user may be, for example, a manner of a pop-up window, and the prompt information may be presented in the pop-up window in a text manner. In addition, the pop-up window may also carry a selection control for the user to select “agree” or “disagree” to provide personal information to the electronic device.

It should be understood that the preceding process of notifying and acquiring user authorization is only illustrative and does not constitute a limitation on implementations of the present disclosure, and other manners that satisfy relevant laws and regulations may also be applied to the implementations of the present disclosure.

In addition, it should be understood that data involved in the technical solutions (including but not limited to the data itself, acquisition or use of the data) should comply with requirements of corresponding laws, regulations and related provisions.

In the related art, a model may be used to automatically generate the text content for live streaming for the user, and the user may perform live streaming or simulation practice of live streaming based on the text content. However, in the related art, the generated text content lacks description of a content structure, which results in a problem of difficulty for the user to understand, and affects the effect of the simulation practice of live streaming by the user based on the text content or the effect of live streaming.

In addition, after the simulation practice, the user needs to repeatedly watch a recorded video or a recorded audio file of the practice to analyze deficiencies in the practice process, which is inefficient.

In view of this, embodiments of the present disclosure provide a text content generation method and apparatus, a medium, an electronic device, and a program product.

The present disclosure is further explained and illustrated below with reference to the drawings.

FIG. 1 is a flowchart of a text content generation method according to an exemplary embodiment of the present disclosure. The method may be applied to an electronic device. The method may be performed by a text content generation apparatus. The apparatus may be implemented by software and/or hardware. The software and/or hardware may be configured in the electronic device. Referring to FIG. 1, the method may include the following steps.

In step 110, displaying an information configuration interface, where the information configuration interface is configured to configure an attribute value of a preset attribute field of a to-be-recommended object.

In step 120, generating, in response to a triggered generation operation, target text content based on the attribute value configured in the information configuration interface, where the target text content is used for live streaming, and the target text content includes a tag field and text content corresponding to the tag field, where the tag field is used to characterize a content structure of the target text content.

In the preceding manner, the target text content includes the tag field and the text content corresponding to the tag field, and the tag field is used to characterize the content structure of the target text content, so that when the user browses the target text content, the user can clearly understand the content structure of the target text content, which is convenient for the user to understand the target text content, thereby providing a data basis for improving the live streaming effect.

In the present disclosure, the user may perform live streaming based on the target text content or perform practice of live streaming based on the target text content. As an example, the target text content may include text content related to the to-be-recommended object, or may include text content related to the to-be-recommended object and interaction content for simulating interacting with a user watching the live streaming.

In the present disclosure, the to-be-recommended object may refer to a commodity, such as a book, food, clothes, and the like. The present disclosure is exemplarily described below by using a commodity as the to-be-recommended object.

In the present disclosure, the attribute value corresponding to the preset attribute field is used to describe the to-be-recommended object. The preset attribute field is, for example, a selling point attribute field, a name attribute field, a category attribute field, a discount attribute field, and the like. Some preset attribute fields may support automatic filling of attribute values, and attribute values of some preset attribute fields need to be selected by the user. For a specific configuration, reference may be made to the following embodiments.

In a possible manner, the information configuration interface may also be configured to configure a name attribute field of the user, and the name attribute field of the user may be set with a default attribute value. In addition, the name attribute field of the user may also support independent modification by the user. When the user independently configures the attribute value of the name attribute field of the user, if it is detected that the attribute value of the name attribute field of the user is the same as the configured attribute value of the name attribute field of the user, the electronic device may display first prompt information, where the first prompt information is used to prompt the user that the same user name cannot be repeatedly configured. As an example, the first prompt information may be “the user name cannot be repeated”.

In the present disclosure, step 110 may be implemented by: displaying the information configuration interface in response to a triggered information configuration operation. The information configuration operation may be a single-click operation or a double-click operation on an information configuration control.

In a possible manner, the electronic device may display the generated target text content in response to a display operation for the target text content, which is convenient for the user to browse.

In a possible manner, the to-be-recommended object may be an object that acquires attribute values through a preset interface. Correspondingly, the information configuration interface includes a first information configuration interface, and the first information configuration interface is further configured to configure the to-be-recommended object. The object that can acquire the attribute values through the preset interface belongs to an online object, and the object is an object stored in a commodity library. Such object maintains the attribute values of the preset attribute fields, and thus can acquire the attribute values through the preset interface. Therefore, the method may further include: acquiring, in response to an object selection operation triggered for the first information configuration interface, an attribute value of a preset attribute field of a to-be-recommended object corresponding to the object selection operation through the preset interface; and automatically filling, according to the attribute value, the attribute value corresponding to the preset attribute field in the first information configuration interface.

It should be noted that the to-be-recommended object may be configured through the object selection operation.

In the present disclosure, the attribute value of the preset attribute field of the selected to-be-recommended object may be acquired through an interface. The preset attribute field herein may refer to a field that supports automatic filling of an attribute value. For example, the preset interface may be obtained by acquiring and analyzing information of the selected to-be-recommended object, where the information herein may refer to information including an attribute value, for example, a commodity details page of the to-be-recommended object. The commodity details page describes selling point information (corresponding to an attribute value of a selling point attribute field) and discount promotion information (corresponding to an attribute value of a discount attribute field) of the commodity, and the selling point information and the discount promotion information may be image information and text information. Therefore, the corresponding attribute value may be extracted based on semantic understanding and image analysis of the commodity details page and returned through the preset interface, to realize automatic acquisition of the attribute value of the preset attribute field of the to-be-recommended object.

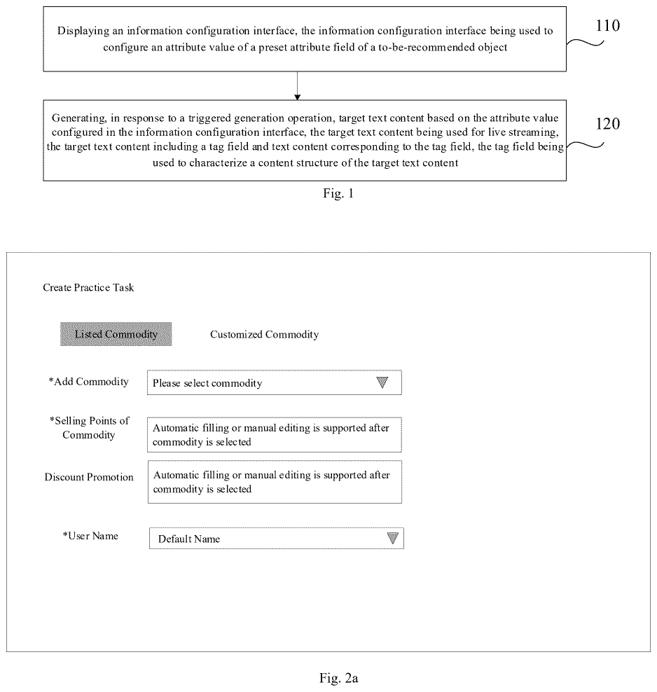

FIG. 2a is a schematic diagram of a first information configuration interface according to an exemplary embodiment of the present disclosure. In FIG. 2a, an adding control “*add commodity” for adding a commodity is provided. In response to the object selection operation triggered for the adding control, a process of acquiring the attribute value of the preset attribute field of the selected to-be-recommended object through the preset interface may be triggered, and the acquired attribute value is automatically filled into the corresponding preset attribute field. FIG. 2b is another schematic diagram of the first information configuration interface according to an exemplary embodiment of the present disclosure. FIG. 2b is a diagram of an interface after the attribute values of the preset attribute fields are automatically filled. Continuing to refer to FIG. 2b, the preset attribute fields for which the attribute values are automatically filled are, for example, a selling point attribute field and a discount attribute field of the commodity.

It should be noted that the first information configuration interface shown in FIG. 2a and FIG. 2b further includes a name edit control “*user name” for editing the name attribute field of the user. The attribute value of the name attribute field of the user is independently modified by the trigger operation on the name edit control.

It should be noted that the control “*add commodity” may support a search function of the commodity. After the user inputs a keyword, a list of commodities matching the keyword may be provided for the user to perform the object selection operation.

It should be noted that after the attribute values are automatically filled, the user's independent modification may also be supported. Before the automatic filling, the first information configuration interface may display second prompt information corresponding to the preset attribute field, to prompt the user that the automatic filling and the user's independent modification are supported after the commodity is selected. The second prompt information may refer to the example shown in FIG. 2a. For the preset attribute field that can be set with a plurality of attribute values, the second prompt information corresponding to the preset attribute field may further prompt the user to independently input a format of the attribute values. For example, a preset symbol needs to be configured between two attribute values.

In the preceding manner, the function of automatic acquisition of the attribute values is utilized to realize automatic acquisition of the attribute values without manual filling by the user, thereby improving the efficiency of configuring the attribute values of the to-be-recommended object. In addition, the user's independent modification of the attribute values is supported, thereby improving the practicality of the overall solution.

In a possible manner, the to-be-recommended object may also be an object that acquires the attribute value based on an input operation of the user. Correspondingly, the information configuration interface includes a second information configuration interface. Compared with the object that can acquire the attribute value from the preset interface, the object that acquires the attribute value based on the input operation of the user belongs to an offline object. The commodity library does not maintain such object, and hence does not maintain the attribute value. Thus, the attribute value cannot be acquired through the preset interface. Therefore, the method may further include: displaying, in response to an input operation triggered for a preset attribute field in the second information configuration interface, input data corresponding to the input operation in the second information configuration interface, where the input data is used to characterize the attribute value of the preset attribute field.

In this embodiment, the preset attribute field may include a name attribute field, a category attribute field, a selling point attribute field, a discount attribute field, and the like that describe the to-be-recommended object. The input operation may be performed for each preset attribute field.

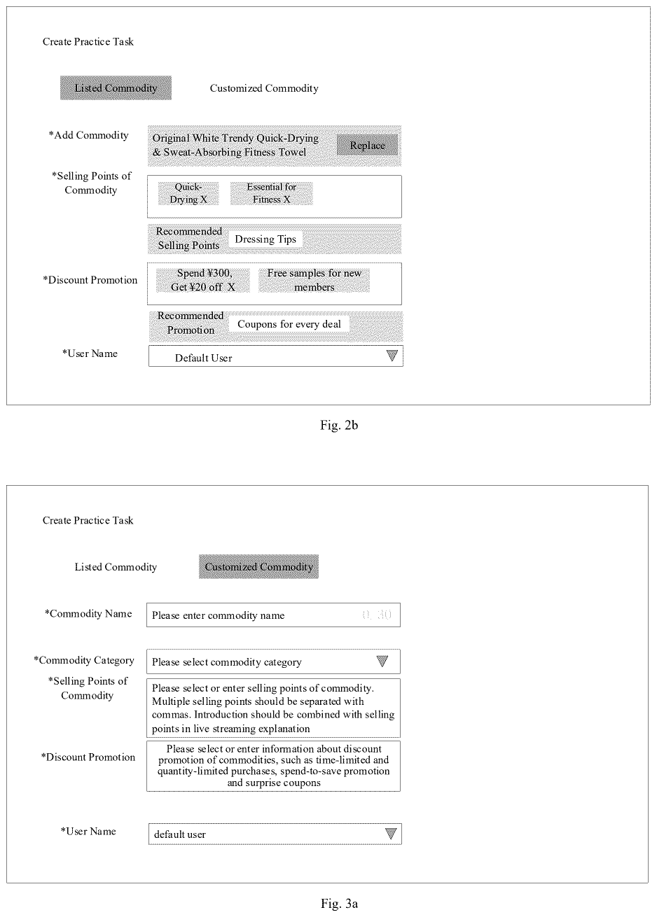

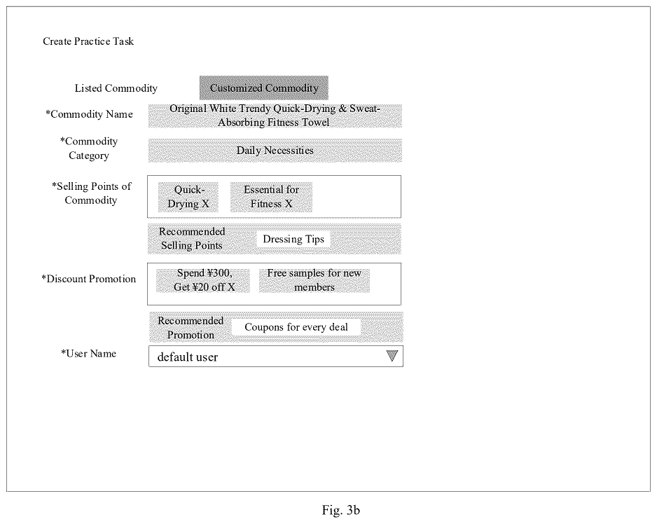

FIG. 3a is a schematic diagram of a second information configuration interface according to an exemplary embodiment of the present disclosure. In FIG. 3a, a control corresponding to a preset attribute field is provided, and corresponding input data is displayed according to an input operation on the corresponding control. FIG. 3b is another schematic diagram of the second information configuration interface according to an exemplary embodiment of the present disclosure. FIG. 3b is a diagram of an interface after the attribute value of the corresponding preset attribute field is configured based on the input operation. Continuing to refer to FIG. 3b, the preset attribute field is, for example, a name attribute field, a category attribute field, a selling point attribute field, and a discount attribute field that describe the to-be-recommended object. For these preset attribute fields, the user can independently edit the attribute values.

It should be noted that the second information configuration interface shown in FIG. 3a and FIG. 3b further includes a name edit control “*user name” for editing the name attribute field of the user. The attribute value of the name attribute field of the user is independently edited by the trigger operation on the name edit control.

In this embodiment, when the attribute value of the preset attribute field is not configured yet, third prompt information corresponding to the preset attribute field may be displayed. For example, for the name attribute field and the category attribute field, the third prompt information may be used to prompt a maximum number of words of input data allowed to be input by the user and the number of words of input data that the user has input. For another example, for the preset attribute field that can be set with a plurality of attribute values, for example, the selling point attribute field, the third prompt information may prompt the user to independently input a format of the attribute values. For example, a preset symbol needs to be configured between two attribute values.

In the preceding manner, the configuration of the attribute value of the corresponding to-be-recommended object is configured through the user input.

In the present disclosure, a switch between the first information configuration interface and the second information configuration interface may be implemented through an object switching control. Continuing to refer to FIG. 2a, the object switching control may be “listed commodity” and “customized commodity” shown in FIG. 2a. A corresponding first information configuration interface or second information configuration interface is displayed by selecting a certain object switching control.

It should be noted that it may be configured such that after the information configuration operation is triggered, the first information configuration interface or the second information configuration interface is displayed by default.

In the present disclosure, when the target text content is generated, the preset attribute field may include a field for which an attribute value must be configured, and may also include a field for which an attribute value does not need to be configured. For the field for which the attribute value must be configured, corresponding fourth prompt information may be displayed to prompt that the attribute value must be configured for the field. For example, when the preset attribute field is a selling point attribute field, the fourth prompt information is “the attribute value corresponding to the selling point attribute field is key information in the text content for live streaming, and is a required item”.

In the present disclosure, the generation operation may be triggered through the generation operation, for example, the generation operation is triggered through single-click or double-click. Further, when the attribute value is not configured for the preset attribute field for which the attribute value must be configured, the generation operation may be in a disabled state, that is, the generation operation cannot be triggered.

In a possible manner, the preset attribute field includes an attribute field that provides candidate attribute values. In this case, after the to-be-recommended object is configured, the method may further include: displaying, in the information configuration interface, at least one target control, where each of the at least one target control corresponds to one candidate attribute value corresponding to the preset attribute field, and the candidate attribute value is obtained through prediction based on information of the to-be-recommended object; and using, in response to a trigger operation for the target control, a candidate attribute value corresponding to the target control as the attribute value of the preset attribute field.

It should be noted that the candidate attribute value is an attribute value provided for the user to quickly configure. For the object that acquires the attribute value through the preset interface, the information of the to-be-recommended object may be a commodity details page of the to-be-recommended object, and thus the candidate attribute value may be obtained through prediction based on the commodity details page of the to-be-recommended object. For the object that acquires the attribute value based on the input operation of the user, the information of the to-be-recommended object may be an attribute value of the name attribute field and an attribute value of the category attribute field that are input by the user and that describe the to-be-recommended object, and thus the candidate attribute value may be obtained through prediction based on the attribute value of the name attribute field and the attribute value of the category attribute field that are input by the user. In a possible manner, a large language model (LLM) may be used for prediction.

Continuing with the preceding example, in this embodiment, the attribute field that provides the candidate attribute value may be the selling point attribute field and the discount attribute field. Continuing to refer to FIG. 2b and FIG. 3b, for the selling point attribute field, a target control “dressing tips” is displayed; and for the discount attribute field, a target control “coupons for every deal” is displayed.

In the present disclosure, the trigger operation for the target control may be realized based on the single-click operation on the target control.

At the same time, the configured attribute value may also support a cancel operation. Continuing to refer to FIG. 3b in which the attribute values are configured, the configured attribute value may be deleted based on a delete control corresponding to each attribute value, for example, a delete control “quick-drying X” corresponding to the attribute value “quick-drying” in FIG. 3b.

In the preceding manner, the attribute value is recommended to the user, which reduces the difficulty of configuring the attribute value, thereby improving the efficiency of configuring the attribute value.

In a possible manner, step 120 may be implemented by: generating, in response to the triggered generation operation, target text content corresponding to each content generation model by using different content generation models based on the attribute values configured in the information configuration interface.

The target text content generated by different content generation models is different. As an example, the target text content may be different in style, for example, a formal style and an informal style. The informal style is a humorous style, as opposed to the formal style. As another example, the target text content may be different in emphasis. For example, the emphasis in the target text content may be focused on introducing the content of the commodity, and the emphasis in the target text content may also be focused on introducing the interaction content when introducing the commodity.

The different content generation models may be obtained by using different training data, thereby realizing generation of different target text content. As an example, the content generation model may be a large language model.

It can be learned from the preceding content that the target text content needs to include the tag field that describes the content structure. When the content generation model is trained, the following structure rules may be used as rules for generating the target text content, to guide the generation of the target text content, so that the trained content generation model has the capability of generating the target text content expressing the content structure. The structure rules may refer to the following table.

The secondary tag is a tag at a next level of the primary tag. The primary tag and the secondary tag in the table are used to characterize the content structure of the target text content. In other embodiments, a tertiary tag may also be set under the secondary tag.

According to the preceding table, the generated target text content may be:

| | | Upper limit | Lower limit | |
|---|---|---|---|---|
| First-level | Second-level | of number | of number | |
| tag | tag | of sentences | of sentences | Explanation |
| Tag A | Tag A1 | ≤2 | >1 | Tag A1 is XX |
| | Tag A2 | | | Tag A2 is XX |
| | Tag A3 | ≤3 | | Tag A3 is XX |
| | Tag A4 | | | Tag A4 is XX |
| Tag B | Tag B1 | ≤6 | >3 | Tag B1 is XX |
| | Tag B2 | ≤3 | | Tag B2 is XX |
| | Tag B3 | ≤6 | | Tag B3 is XX |
| Tag C | Tag C1 | ≤4 | ≥1 | Tag C1 is XX |
| | Tag C2 | ≤1 | | Tag C2 is XX |
| | Tag C3 | ≤1 | | Tag C3 is XX |

The second-level tag is a tag at a next level of the first-level tag. The first-level tag and the second-level tag in the table are used to characterize the content structure of the target text content. In other embodiments, a third-level tag may also be set under the second-level tag.

According to the preceding table, the generated target text content may be:

```
“ [Tag A]
<Tag A1>XXXX.
<Tag A2>XXXX.
  [Tag B]
<Tag B1>XXXXXXXXXX.
<Tag B2>XXXXXXXXXX.
  [Tag C]
<Tag C1>XXXX.
<Tag C2>XXXX.”
```

In the preceding manner, a plurality of versions of the target text content are provided for the user to browse, thereby improving the richness of data and supporting the user to select preferred target text content from the plurality of versions of the target text content.

In the present disclosure, a generation interface is displayed in parallel with the information configuration interface. The generation operation may be displayed in the generation interface and used to trigger the generation operation.

In the present disclosure, after the target text content is generated, the target text content may be displayed in a display interface. The display interface and the information configuration interface may be displayed in parallel.

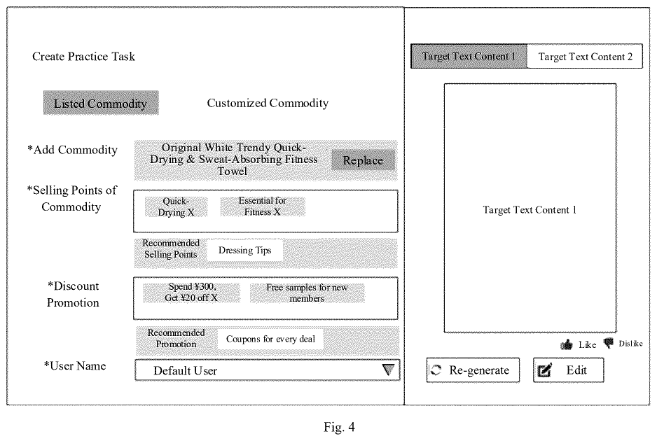

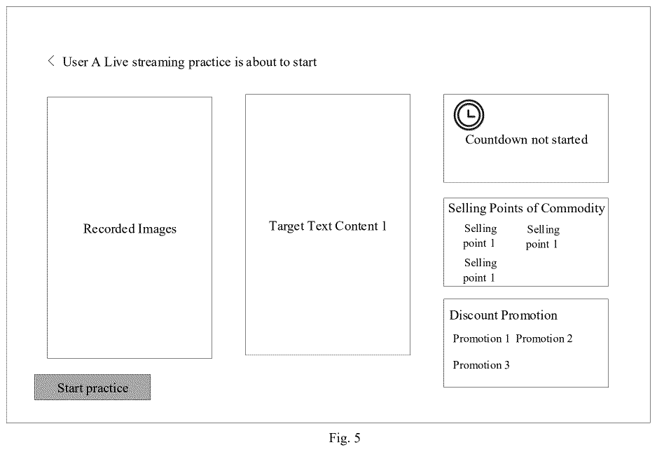

FIG. 4 is a schematic diagram of an interface of a display interface and an information configuration interface according to an exemplary embodiment of the present disclosure. Referring to FIG. 4, the display interface and the information configuration interface may be displayed in parallel. In the display interface, target text content generated by different content generation models may be switched and displayed through a switching control “target text content 1” or “target text content 2” for switching and displaying the target text content.

Continuing to refer to FIG. 4, the user may re-generate the target text content corresponding to the content generation model by triggering a “re-generate” control for re-generating the target text content. In other embodiments, an operation for re-generating the text content corresponding to each tag field may be triggered to correspondingly re-generate the text content of some tag fields.

Continuing to refer to FIG. 4, the user may edit the target text content independently by triggering an “edit” control for editing the target text content. After the editing, the user may also perform a save operation through the electronic device. After the user edits and before the save operation is performed through the electronic device, when an operation such as refreshing a page or closing a page is performed, fifth prompt information may be displayed to prompt the user to perform the save operation through the electronic device. In other embodiments, when there are many idle resources, each edit operation of the user may trigger an auto save.

In a possible manner, after the target text content is generated, the method may further include: displaying prompt information in response to a modification operation for the attribute value, where the prompt information is used to prompt whether to re-generate the target text content.

After the prompt information is displayed, the user may decide whether to trigger the generation operation according to an actual situation. After the generation operation is triggered, the target text content corresponding to each content generation model may be re-generated by using different content generation models based on the attribute values configured in the information configuration interface.

In a possible manner, the method may further include: acquiring user feedback data, where the user feedback data is used to characterize an evaluation of the user for the target text content generated by each content generation model; and determining, according to the user feedback data, whether to update each content generation model.

The user feedback data may characterize an evaluation of the user on whether the user is satisfied with the generated target text content. Continuing to refer to FIG. 4, the user may trigger a trigger operation of a control “like” or a control “dislike” to realize the evaluation of the generated target text content. It may be understood that “like” represents a satisfactory evaluation, and “dislike” represents an unsatisfactory evaluation.

In the present disclosure, the user feedback data in the preset time period may be counted to determine whether to update each content generation model. For example, for the content generation model, if in the user feedback data within the preset time period, the number or proportion of evaluations that are unsatisfactory exceeds a preset number or a preset proportion, it is determined to update the content generation model: otherwise, it is determined not to update the content generation model.

In the preceding manner, whether to update the content generation model is determined by using the feedback data of the user for the target text content, so as to ensure that the content generation model can meet the requirement of the user for the content.

In the present disclosure, the user may select from a plurality of pieces of target text content and perform live streaming practice based on the selected target text content. As an example, after selecting the target text content used for live streaming practice and triggering an operation of entering a practice interface by the user, a practice interface may further be displayed. FIG. 5 is a schematic diagram of a practice interface according to an exemplary embodiment of the present disclosure. A practice control “start practice” may be triggered to start recording the live streaming practice. If the practice control is triggered when the user does not select the target text content used for live streaming practice, sixth prompt information may be displayed, where the sixth prompt information is used to prompt the user to select the target text content.

In the present disclosure, before the recording, it is necessary to acquire permission to use a microphone and a camera and detect whether the microphone and the camera are available. If the permission to use the microphone and the camera is not acquired or the microphone and the camera are not detected, seventh prompt information is displayed, where the seventh prompt information is used to prompt the user that the microphone and the camera are abnormal, and the user is requested to try again.

In the present disclosure, the recording may simultaneously record audio and images in the live streaming practice process to obtain a corresponding multimedia file.

In the present disclosure, after triggering the recording by the user, a countdown for starting the recording may be displayed in the practice interface. The countdown may display information of minutes and seconds. For different categories of to-be-recommended objects, the duration of the countdown as configured may be different.

In the present disclosure, the recording may be performed according to a recording parameter configured in advance. For example, the size of a recorded image may be the same as the size of a live streaming image.

In the present disclosure, the recording may be saved in real time during the recording process, or the multimedia file obtained through the recording is saved after the save operation triggered by the user is received.

In the present disclosure, the target text content may only include the content related to the commodity, and there is no interactive content. Therefore, eighth prompt information may also be displayed in the practice interface. The eighth prompt information is used to prompt the user that interaction may be added to the practice to be closer to a live streaming scenario.

In the present disclosure, in the recording process, the user may trigger an operation of ending the recording through the electronic device, and the electronic device displays ninth prompt information in response to the operation. The ninth prompt information is used to prompt the user to determine whether to confirm to end the recording, and the recording result may be scored after the recording is ended. While displaying the ninth prompt information, a confirmation control and a cancel control are displayed to support the user to submit an instruction which confirms to end the recording, or submit an instruction which cancels ending the recording.

Continuing to refer to FIG. 5, in the present disclosure, in the practice interface, the target text content and the recorded image may be synchronously provided, and selling point attribute values (e.g., selling point 1, selling point 2, etc. shown in FIG. 5) and discount attribute values (e.g., promotion 1, promotion 2, etc. shown in FIG. 5) involved in the target text content may also be synchronously provided.

In a possible manner, the method may further include: acquiring a to-be-evaluated multimedia file, where the multimedia file is recorded when the user performs the live streaming practice based on the target text content; determining report content based on a preset strategy according to the multimedia file; and generating an analysis report of the multimedia file according to the report content, where the analysis report is used to reflect a language expression capability of the user.

In the present disclosure, the user may trigger an operation of scoring the recording result through the electronic device, and tenth prompt information is displayed after the operation is triggered. The tenth prompt information is used to prompt the user that the recording result has been submitted and the corresponding analysis report is being generated.

In the present disclosure, the multimedia file may be a video file or an audio file. This is not limited in the embodiments of the present disclosure.

In the present disclosure, the electronic device may display the analysis report in response to a display operation for the analysis report triggered by the user, which is convenient for the user to browse.

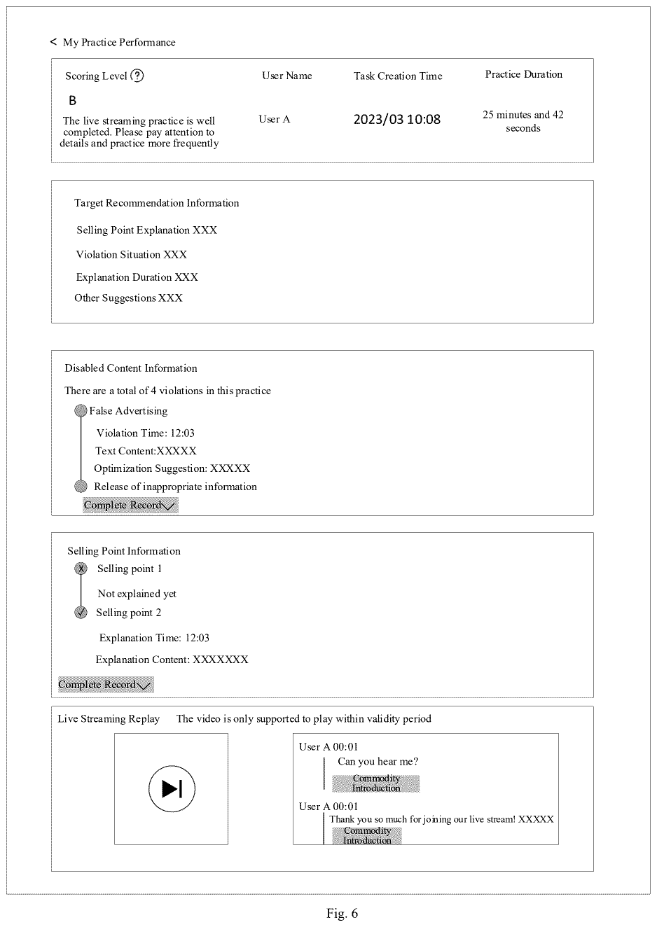

The following exemplarily describes the present disclosure with reference to FIG. 6 by using an example in which the report content includes the scoring information, the task information, the first suggestion information, the disabled content information, the selling point information, and the labeling information. FIG. 6 is a schematic diagram of an interface of an analysis report displayed according to an exemplary embodiment of the present disclosure.

In the present disclosure, the scoring information may include a scoring score and an evaluation text corresponding to the scoring score. The scoring score may be set with a corresponding scoring level, for example, level A, level B, level C, and level D. Referring to FIG. 6, the scoring score may be displayed with the corresponding scoring level during display. Further, an explanation control for the scoring level may be triggered to display a relationship between the scoring level and the scoring score.

In the present disclosure, the report content may include the scoring information, the preset attribute field includes the selling point attribute field, and the step in which the report content is determined based on the preset strategy according to the multimedia file may include: determining the scoring score according to a difference between a duration of the multimedia file and a preset standard duration, a difference between text content describing a selling point in the multimedia file and the configured attribute value of the selling point attribute field, and the number of occurrences of a preset prohibited word in the text content corresponding to the multimedia file; and determining the evaluation text corresponding to the scoring score according to the scoring score.

For example, score weights occupied by a plurality of scoring items may be set. As an example, the scoring item may include an explanation duration scoring item, and the explanation duration scoring item corresponds to the difference between the duration of the multimedia file and the preset standard duration. The explanation duration scoring item may be set with a highest score of 10 points, and the score is determined according to the difference between the duration of the multimedia file and the preset standard duration. The greater the difference, the lower the score; and the smaller the difference, the higher the score.

As an example, the scoring item may include a selling point explanation scoring item, and the selling point explanation scoring item corresponds to the difference between the text content describing the selling point in the multimedia file and the configured attribute value of the selling point attribute field. The selling point explanation scoring item may be set with a highest score of 40 points, and the score is determined according to the difference between the text content describing the selling point in the multimedia file and the configured attribute value of the selling point attribute field. For example, the score may be characterized by:

S=C1/C2*40;

where S represents the score, C1 represents the number of types of selling points involved in the multimedia file, and may be obtained by analyzing the text content describing the selling point in the multimedia file, and C2 represents the number of configured attribute values of the selling point attribute field.

As an example, the scoring item may include a content specification scoring item, and the content specification scoring item corresponds to the number of occurrences of the preset prohibited word in the text content corresponding to the multimedia file. The content specification scoring item may be set with a highest score of 50 points, and the score is determined according to the number of occurrences of the preset prohibited word in the text content corresponding to the multimedia file. The larger the number of occurrences, the lower the score.

In the present disclosure, the preset prohibited word may be configured in advance, and whether the preset prohibited word appears in the text content is determined based on semantic configuration.

In the present disclosure, the evaluation text corresponding to the scoring score may be configured in advance. When the analysis report is determined, the evaluation text corresponding to the scoring score is directly acquired.

Continuing to refer to FIG. 6, the report content may further include the task information, and the task information may be the user name information, task creation time information, and continuous duration information, which may be obtained from the configuration information in the information configuration interface and the process of recording the multimedia file by the user.

In the present disclosure, the report content may further include the first suggestion information. The step in which the report content is determined based on the preset strategy according to the multimedia file may further include: determining whether the text content corresponding to the multimedia file satisfies a condition corresponding to a suggestion text; and determining the suggestion text corresponding to the satisfied condition as the first suggestion information.

As an example, the condition corresponding to the suggestion text may include a condition related to the selling point attribute field. Specifically, the condition corresponding to the suggestion text may be that an attribute value of the selling point attribute field described in the text content of the multimedia file does not completely cover the attribute value related to the selling point attribute field in the target text content.

As an example, the condition corresponding to the suggestion text may include a condition related to the preset prohibited word. Specifically, the condition corresponding to the suggestion text may be that there is text content matching the preset prohibited word in the text content of the multimedia file.

As an example, the condition corresponding to the suggestion text may include that the duration of the multimedia file is less than a preset duration threshold. The preset duration threshold may be 8 minutes.

The first suggestion information may be obtained by splicing all the suggestion texts corresponding to the satisfied conditions.

It should be understood that the suggestion text corresponding to the condition may be configured in advance. When the suggestion text is displayed, a dimension corresponding to the suggestion text is synchronously displayed, for example, a selling point explanation dimension, a prohibited word condition dimension, and an explanation duration dimension as shown in FIG. 6.

In the present disclosure, the report content may further include second suggestion information, and the second suggestion information is “other suggestions” as shown in FIG. 6. The second suggestion information is suggestion information that is common and necessary in any analysis report, and the second suggestion information is used to prevent the user from guiding the consumer to perform offline transactions or transactions on other platforms (non-live streaming platforms), to maintain security.

In the present disclosure, the report content may further include disabled content information. The step in which the report content is determined based on the preset strategy according to the multimedia file may further include: determining whether there is a text matching the preset prohibited word in the text content corresponding to the multimedia file: determining the text matching the preset prohibited word in the text content as disabled content; and determining the disabled content information according to all the disabled content.

The matching between the text content and the preset prohibited word may be implemented based on semantics.

Continuing to refer to FIG. 6, the disabled content information includes the number of occurrences of the preset prohibited word in the text content corresponding to the multimedia file, the prohibited word label (e.g., false advertising in FIG. 6) corresponding to the occurred preset prohibited word, the occurrence time (e.g., occurrence start time in FIG. 6) of the text content (e.g., the text content: XXXXX in FIG. 6) corresponding to the preset prohibited word in the multimedia file, and the corresponding optimization suggestions.

When there is much text content corresponding to the occurred preset prohibited word, the text content may be displayed in a folding manner, and a control for displaying all the content is provided, for example, “complete record” as shown in FIG. 6, which is used to trigger display of the text content corresponding to all the preset prohibited words.

In the present disclosure, it can be learned from the preceding content that the preset attribute field includes the selling point attribute field. In this case, the report content further includes the selling point information, and the selling point information is used to characterize whether the configured attribute value corresponding to the selling point attribute field is covered by the text content corresponding to the multimedia file. The step in which the report content is determined based on the preset strategy according to the multimedia file may further include: comparing first text content with second text content to obtain a comparison result, where the first text content is the text content corresponding to the multimedia file, and the second text content is the configured attribute value corresponding to the selling point attribute field; and determining selling point comparison information according to the comparison result.

The selling point comparison information includes the configured attribute value corresponding to the selling point attribute field. The display content corresponding to an attribute value covered by the text content corresponding to the multimedia file and the display content corresponding to an attribute value not covered by the text content corresponding to the multimedia file have different display styles. Continuing to refer to the example shown in FIG. 6, firstly, the configured attribute values corresponding to the selling point attribute field may be displayed in the configuration order, and the display content corresponding to the attribute values covered by the text content corresponding to the multimedia file is distinguished from the display content corresponding to the attribute values not covered by the text content corresponding to the multimedia file in display style. Based on the difference in display styles, the user can clearly distinguish between the selling point explained and the selling point not explained in the practice process. The display content in this embodiment may include the attribute values corresponding to the selling point attribute field (e.g., selling point 1 and selling point 2 in FIG. 6), the text content corresponding to the attribute value covered by the text content corresponding to the multimedia file (e.g., the explanation content in FIG. 6), and the occurrence time of the text content in the multimedia file.

When there is much display content, the display content may be displayed in the folding manner, and a control for displaying all the display content is provided, for example. “complete record” as shown in FIG. 6, which is used to trigger display of all the display content.

In the present disclosure, the report content may further include the labeling information, and the labeling information is used to characterize the text content corresponding to the multimedia file and the content structure of the text content. The step in which the report content is determined based on the preset strategy according to the multimedia file may further include: segmenting the text content corresponding to the multimedia file to obtain at least one sub-text: for each of the at least one sub-text, determining the tag field matching the sub-text in semantics, and labeling the sub-text according to the tag field matching the sub-text in semantics to obtain a labeling result of the sub-text, where the labeling result characterizes the content structure; and generating the labeling information according to each of the sub-texts and the labeling result corresponding to each of the sub-texts.

Time segments of the multimedia file may be divided, and text extraction is performed for each time segment to obtain at least one sub-text.

The tag field in this embodiment is the tag field involved in the target text content, and reference may be made to the tag field provided in the preceding table. As an example, the at least one sub-text in the labeling information is displayed in an order of occurrence time in the multimedia file. When the sub-text is displayed, the tag field corresponding to the sub-text is displayed at the same time. Continuing to refer to the example shown in FIG. 6, when the sub-text “Can you hear me?” is displayed, the tag field “commodity introduction” is displayed.

Continuing to refer to FIG. 6, in the present disclosure, the report content may further include a video corresponding to the multimedia file. The video is played and paused by triggering a play control as shown in FIG. 6, and the user is supported to control a playing parameter in the playing process. The playing parameter is, for example, a playback progress, a playback volume, and the like. In addition, ninth prompt information may be further displayed, and the ninth prompt information is used to prompt that the video is only supported to play within a validity period.

After the respective report content is obtained, the respective report content is spliced, to obtain the analysis report, for example, the analysis report shown in FIG. 6.

In the preceding manner, the multimedia file recorded when the user performs the live streaming practice based on the target text content is evaluated in a plurality of dimensions such as explanation duration and explanation content, and the text content corresponding to the multimedia file is labeled in a structured manner, so that the user can quickly and clearly understand the missing content when tracing back to the recording structure, which is beneficial for the user to perform targeted live streaming practice on the missing content, thereby improving the live streaming effect.

In a possible manner, the analysis report of the multimedia file may be returned to a task configuration platform, and the task configuration platform may determine, according to the analysis report, whether to allocate the task of re-performing the live streaming practice to the user client where the user is located.

In this manner, the user may be motivated to continuously improve the effect of the live streaming practice, thereby improving the live streaming effect.

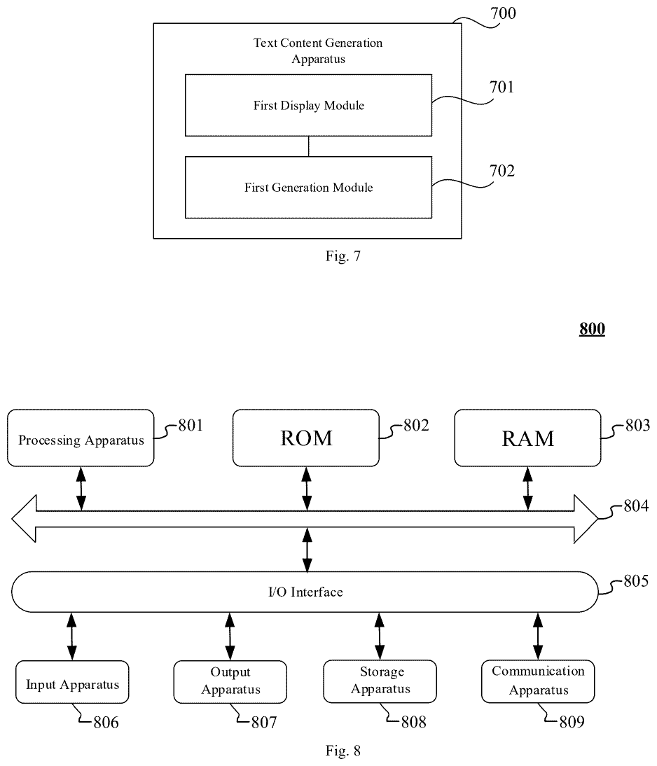

FIG. 7 is a block diagram of a text content generation apparatus according to an exemplary embodiment of the present disclosure. Referring to FIG. 7, the text content generation apparatus 700 includes a first display module 701 and a first generation module 702.

The first display module 701 is configured to display an information configuration interface, where the information configuration interface is configured to configure an attribute value of a preset attribute field of a to-be-recommended object.

The first generation module 702 is configured to generate, in response to a triggered generation operation, target text content based on the attribute value configured in the information configuration interface, where the target text content is used for live streaming, the target text content includes a tag field and text content corresponding to the tag field, and the tag field is used to characterize a content structure of the target text content.

Optionally, the to-be-recommended object includes an object that acquires attribute values through a preset interface, the information configuration interface includes a first information configuration interface, the first information configuration interface is further configured to configure the to-be-recommended object, and the apparatus 700 further includes a first response module and a filling module.

The first response module is configured to acquire, in response to an object selection operation triggered for the first information configuration interface, an attribute value of a preset attribute field of a to-be-recommended object corresponding to the object selection operation through the preset interface.

The filling module is configured to automatically fill, according to the attribute value, the attribute value corresponding to the preset attribute field in the first information configuration interface.

Optionally, the to-be-recommended object includes an object that acquires an attribute value based on an input operation of the user, the information configuration interface includes a second information configuration interface, and the apparatus 700 further includes a second response module.

The second response module is configured to display, in response to an input operation triggered for a preset attribute field in the second information configuration interface, input data corresponding to the input operation in the second information configuration interface, where the input data is used to characterize the attribute value of the preset attribute field.

Optionally, the preset attribute field includes an attribute field that provides a candidate attribute value, and the apparatus 700 further includes a second display module and a third response module.

The second display module is configured to, after the to-be-recommended object is configured, display, in the information configuration interface, at least one target control, where each of the at least one target control corresponds to one candidate attribute value corresponding to the preset attribute field, and the candidate attribute value is obtained through prediction based on information of the to-be-recommended object.

The third response module is configured to use, in response to a trigger operation for the target control, a candidate attribute value corresponding to the target control as the attribute value of the preset attribute field.

Optionally, the first generation module 702 is further configured to generate, in response to the triggered generation operation, target text content corresponding to each content generation model by using different content generation models based on the attribute values configured in the information configuration interface.

Optionally, the apparatus 700 further includes a fourth response module.

The fourth response module is configured to display prompt information in response to a modification operation for the attribute value after the target text content is generated, where the prompt information is used to prompt whether to re-generate the target text content.

Optionally, the apparatus 700 further includes a first acquisition module and a first determination module.

The first acquisition module is configured to acquire user feedback data, where the user feedback data is used to characterize an evaluation of the user for the target text content generated by each content generation model.

The first determination module is configured to determine, according to the user feedback data, whether to update each content generation model.

Optionally, the apparatus 700 further includes a second acquisition module, a second determination module, and a second generation module.

The second acquisition module is configured to acquire a to-be-evaluated multimedia file, where the multimedia file is recorded when the user performs live streaming practice based on the target text content.

The second determination module is configured to determine report content based on a preset strategy according to the multimedia file.

The second generation module is configured to generate an analysis report of the multimedia file according to the report content, where the analysis report is used to reflect a language expression capability of the user.

Optionally, the report content includes scoring information, the scoring information includes a scoring score and an evaluation text corresponding to the scoring score, the preset attribute field includes a selling point attribute field, and the second determination module includes a first determination sub-module and a second determination sub-module.

The first determination sub-module is configured to determine the scoring score according to a difference between a duration of the multimedia file and a preset standard duration, a difference between text content describing a selling point in the multimedia file and a configured attribute value of the selling point attribute field, and the number of occurrences of a preset prohibited word in the text content corresponding to the multimedia file.

The second determination sub-module is configured to determine the evaluation text corresponding to the scoring score according to the scoring score.

Optionally, the report content includes first suggestion information, and the second determination module includes a third determination sub-module and a fourth determination sub-module.

The third determination sub-module is configured to determine whether the text content corresponding to the multimedia file satisfies a condition corresponding to a suggestion text.

The fourth determination sub-module is configured to determine the suggestion text corresponding to the satisfied condition as the first suggestion information.

Optionally, the report content includes disabled content information, and the second determination module includes a fifth determination sub-module, a sixth determination sub-module, and a seventh determination sub-module.

The fifth determination sub-module is configured to determine whether there is a text matching the preset prohibited word in the text content corresponding to the multimedia file.

The sixth determination sub-module is configured to determine the text matching the preset prohibited word in the text content as disabled content.

The seventh determination sub-module is configured to determine the disabled content information according to all the disabled content.

Optionally, the preset attribute field includes a selling point attribute field, the report content includes selling point information, and the selling point information is used to characterize whether the configured attribute value corresponding to the selling point attribute field is covered by the text content corresponding to the multimedia file. The second determination module includes a comparison sub-module and an eighth determination sub-module.

The comparison sub-module is configured to compare first text content with second text content to obtain a comparison result, where the first text content is the text content corresponding to the multimedia file, and the second text content is the configured attribute value corresponding to the selling point attribute field.

The eighth determination sub-module is configured to determine selling point comparison information according to the comparison result.

Optionally, in the selling point comparison information, display content corresponding to an attribute value covered by the text content corresponding to the multimedia file and display content corresponding to an attribute value not covered by the text content corresponding to the multimedia file have different display styles.

Optionally, the report content includes the labeling information, and the labeling information is used to characterize the text content corresponding to the multimedia file and the content structure of the text content. The second determination module includes a segmentation sub-module, a labeling sub-module, and a generation sub-module.

The segmentation sub-module is configured to segment the text content corresponding to the multimedia file to obtain at least one sub-text.

The labeling sub-module is configured to: for each of the at least one sub-text, determine the tag field matching the sub-text in semantics, and label the sub-text according to the tag field matching the sub-text in semantics to obtain a labeling result of the sub-text, where the labeling result characterizes the content structure.

The generation sub-module is configured to generate the labeling information according to each of the sub-texts and the labeling result corresponding to each of the sub-texts.

Embodiments of the present disclosure provide a computer-readable medium having a computer program stored thereon, where when the computer program is executed by a processing apparatus, the steps of the preceding text content generation method are implemented.

Embodiments of the present disclosure provide a computer program product, including a computer program, where when the computer program is executed by a processor, the steps of the preceding text content generation method are implemented.

Embodiments of the present disclosure provide an electronic device, including:
a storage apparatus having a computer program stored thereon; and
a processing apparatus configured to execute the computer program in the storage apparatus to implement the steps of the preceding text content generation method.

Reference is made to FIG. 8 below, which illustrates a schematic diagram of a structure of an electronic device 800 suitable for implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a tablet computer, a portable multimedia player (PMP), a vehicle-mounted terminal (for example, a vehicle navigation terminal), and a fixed terminal such as a digital TV, a desktop computer, and the like. The electronic device shown in FIG. 8 is only an example and should not impose any limitations on the function and scope of use of the embodiments of the present disclosure.

As shown in FIG. 8, the electronic device 800 may include a processing apparatus 801 (such as a central processing unit and a graphics processor), which may perform various appropriate actions and processing according to a program stored in a read-only memory (ROM) 802 or a program loaded from a storage apparatus 808 into a random-access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Usually, the following apparatuses may be connected to the I/O interface 805: an input apparatus 806 including, for example, a touchscreen, a touchpad, a keyboard, a mouse, a camera, a microphone, an accelerometer, and a gyroscope, etc.; an output apparatus 807 including, for example, a liquid crystal display (LCD), a speaker, and a vibrator, etc.; the storage apparatus 808 including, for example, a magnetic tape and a hard disk, etc.; and a communication apparatus 809. The communication apparatus 809 may allow the electronic device 800 to perform wireless or wired communication with other devices to exchange data. Although FIG. 8 shows the electronic device 800 having various apparatuses, it should be understood that not all of the illustrated apparatuses are necessarily implemented or included. Alternatively, more or fewer apparatuses may be implemented or included.

Particularly, according to the embodiments of the present disclosure, the processes described above with reference to the flowcharts may be implemented as a computer software program. For example, an embodiment of the present disclosure includes a computer program product, which includes a computer program carried on a non-transitory computer-readable medium, and the computer program includes program code for executing the method shown in the flowcharts. In such an embodiment, the computer program may be downloaded and installed from a network through the communication apparatus 809, or installed from the storage apparatus 808, or installed from the ROM 802. When the computer program is executed by the processing apparatus 801, the preceding functions defined in the method of the embodiments of the present disclosure are executed.

It should be noted that the preceding computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination thereof. In the present disclosure, the computer-readable storage medium may be any tangible medium containing or storing a program. The program may be used by or in combination with an instruction execution system, apparatus, or device. In the present disclosure, the computer-readable signal medium may include a data signal propagated in a baseband or as a part of a carrier wave, where computer-readable program code is carried in the data signal. The data signal propagated in this manner may take a plurality of forms, including but not limited to an electromagnetic signal, an optical signal, or any appropriate combination thereof. The computer-readable signal medium may also be any computer-readable medium other than the computer-readable storage medium. The computer-readable signal medium may send, propagate, or transmit a program used by or in combination with the instruction execution system, apparatus, or device. The program code contained in the computer-readable medium may be transmitted by using any appropriate medium, including but not limited to an electric wire, an optical cable, radio frequency (RF), or any appropriate combination thereof.

In some implementations, the electronic device may communicate by using any currently known or future developed network protocol such as hypertext transfer protocol (HTTP) and may be interconnected with digital data in any form or medium (for example, a communication network). Examples of the communication network include a local area network (LAN), a wide area network (WAN), an international network (for example, the internet), a peer-to-peer network (for example, an ad hoc peer-to-peer network), and any currently known or future developed network.

The preceding computer-readable medium may be included in the preceding electronic device, or may exist alone without being assembled into the electronic device.

The preceding computer-readable medium carries one or more programs which, when executed by the electronic device, cause the electronic device to: display an information configuration interface, where the information configuration interface is used to configure an attribute value of a preset attribute field of a to-be-recommended object; and generate, in response to a triggered generation operation, target text content based on the attribute value configured in the information configuration interface, where the target text content is used for live streaming, the target text content includes a tag field and text content corresponding to the tag field, and the tag field is used to characterize a content structure of the target text content.

The computer program code for performing the operations of the present disclosure may be written in one or more programming languages or a combination thereof. The preceding programming languages include object-oriented programming languages such as Java, Smalltalk, and C++, as well as conventional procedural programming languages such as C or similar programming languages. The program code may be executed entirely on a user computer, executed partly on a user computer, executed as a stand-alone software package, executed partly on a user computer and partly on a remote computer, or executed entirely on a remote computer or a server. In the case involving the remote computer, the remote computer may be connected to the user computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that in some alternative implementations, the functions indicated in the blocks may be implemented in an order different from those indicated in the drawings. For example, two blocks shown in succession may, in fact, be executed substantially concurrently, or the two blocks may sometimes be executed in a reverse order, depending on the functions involved. It should also be noted that each block of the block diagrams and/or flowcharts and the combinations of blocks in the block diagrams and/or flowcharts may be implemented by a dedicated hardware-based system that performs the specified functions or operations, or may be implemented by a combination of dedicated hardware and computer instructions.

The modules involved in the embodiments of the present disclosure may be implemented in software or hardware. The name of a module does not constitute a limitation of the module itself under certain circumstances.

The functions described herein above may be performed, at least in part, by one or more hardware logic components. For example, without limitation, exemplary types of hardware logic components that can be used include: a field-programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection with one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The preceding description is merely preferred embodiments of the present disclosure and the illustration of the applied technical principles. It should be understood by those skilled in the art that the scope of disclosure involved in the present disclosure is not limited to the technical solutions formed by the specific combination of the preceding technical features, and should also cover, without departing from the preceding disclosed concept, other technical solutions formed by any combination of the preceding technical features or equivalent features thereof. For example, the technical solutions formed by replacing the preceding features with the technical features having similar functions disclosed in the present disclosure (but not limited to).

In addition, although operations are depicted in a particular order, it should not be understood as that these operations are required to be performed in the particular order as shown or in a sequential order. Under certain circumstances, multitasking and parallel processing may be advantageous. Similarly, although several specific implementation details are included in the preceding discussion, these should not be interpreted as limiting the scope of the present disclosure. Some features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely example forms of implementing the claims. Regarding the apparatus in the preceding embodiments, the specific manner in which the respective modules perform operations has been described in detail in the embodiments related to the methods, and will not be described in detail here.

1. A text content generation method, comprising:
displaying an information configuration interface, wherein the information configuration interface is configured to configure an attribute value of a preset attribute field of a to-be-recommended object; and
generating, in response to a triggered generation operation, target text content based on the attribute value configured in the information configuration interface, wherein the target text content is used for live streaming, the target text content comprises a tag field and text content corresponding to the tag field, and the tag field is used to characterize a content structure of the target text content.

2. The method according to claim 1, wherein the to-be-recommended object comprises an object that acquires an attribute value through a preset interface, the information configuration interface comprises a first information configuration interface, the first information configuration interface is further configured to configure the to-be-recommended object, and
wherein the method further comprises:
acquiring, in response to an object selection operation triggered for the first information configuration interface, an attribute value of a preset attribute field of a to-be-recommended object corresponding to the object selection operation through the preset interface; and
automatically filling, according to the attribute value, the attribute value corresponding to the preset attribute field in the first information configuration interface.

3. The method according to claim 1, wherein the to-be-recommended object comprises an object that acquires an attribute value based on an input operation of a user, the information configuration interface comprises a second information configuration interface, and
wherein the method further comprises:
displaying, in response to an input operation triggered for a preset attribute field in the second information configuration interface, input data corresponding to the input operation in the second information configuration interface, wherein the input data is used to characterize the attribute value of the preset attribute field.

4. The method according to claim 1, wherein the preset attribute field comprises an attribute field that provides a candidate attribute value, and after the attribute value of the preset attribute field of the to-be-recommended object is configured, the method further comprises:
displaying, in the information configuration interface, at least one target control, wherein each of the at least one target control corresponds to one candidate attribute value corresponding to the preset attribute field, and the candidate attribute value is obtained through prediction based on information of the to-be-recommended object; and
using, in response to a trigger operation for the target control, a candidate attribute value corresponding to the target control as the attribute value of the preset attribute field.

5. The method according to claim 1, wherein the generating, in response to a triggered generation operation, target text content based on the attribute value configured in the information configuration interface comprises:
generating, in response to the triggered generation operation, target text content corresponding to each content generation model of different content generation models by using the different content generation models based on the attribute value configured in the information configuration interface.

6. The method according to claim 1, wherein after the target text content is generated, the method further comprises:
displaying prompt information in response to a modification operation for the attribute value, wherein the prompt information is used to prompt whether to re-generate the target text content.

7. The method according to claim 5, further comprising:
acquiring user feedback data, wherein the user feedback data is used to characterize an evaluation of a user for the target text content generated by each content generation model; and
determining, according to the user feedback data, whether to update each content generation model.

8. The method according to claim 1, further comprising:
acquiring a to-be-evaluated multimedia file, wherein the multimedia file is recorded in response to a live streaming practice performed by a user based on the target text content;
determining report content based on a preset strategy according to the multimedia file; and
generating an analysis report of the multimedia file according to the report content, wherein the analysis report is used to reflect a language expression capability of the user.

9. The method according to claim 8, wherein the report content comprises scoring information, the scoring information comprises a scoring score and an evaluation text corresponding to the scoring score, the preset attribute field comprises a selling point attribute field, and
wherein the determining report content based on a preset strategy according to the multimedia file comprises:
determining the scoring score according to a difference between a duration of the multimedia file and a preset standard duration, a difference between text content describing a selling point in the multimedia file and a configured attribute value of the selling point attribute field, and a number of occurrences of a preset prohibited word in text content corresponding to the multimedia file; and
determining the evaluation text corresponding to the scoring score according to the scoring score.

10. The method according to claim 8, wherein the report content comprises first suggestion information, and the determining report content based on a preset strategy according to the multimedia file further comprises:
determining whether text content corresponding to the multimedia file satisfies a condition corresponding to a suggestion text; and
determining the suggestion text corresponding to the satisfied condition as the first suggestion information.

11. The method according to claim 8, wherein the report content comprises disabled content information, and the determining report content based on a preset strategy according to the multimedia file further comprises:
determining whether there is a text matching a preset prohibited word in text content corresponding to the multimedia file;
determining the text matching the preset prohibited word in the text content as disabled content; and
determining the disabled content information according to all the disabled content.

12. The method according to claim 8, wherein the preset attribute field comprises a selling point attribute field, the report content comprises selling point information, the selling point information is used to characterize whether a configured attribute value corresponding to the selling point attribute field is covered by text content corresponding to the multimedia file, and
wherein the determining report content based on a preset strategy according to the multimedia file further comprises:
comparing first text content with second text content to obtain a comparison result, wherein the first text content is the text content corresponding to the multimedia file, and the second text content is the configured attribute value corresponding to the selling point attribute field; and
determining selling point comparison information according to the comparison result.

13. The method according to claim 12, wherein in the selling point comparison information, display content corresponding to an attribute value covered by the text content corresponding to the multimedia file and display content corresponding to an attribute value not covered by the text content corresponding to the multimedia file have different display styles.

14. The method according to claim 8, wherein the report content comprises labeling information, the labeling information is used to characterize text content corresponding to the multimedia file and a content structure of the text content, and
wherein the determining report content based on a preset strategy according to the multimedia file further comprises:
segmenting the text content corresponding to the multimedia file to obtain at least one sub-text;
determining, for each of the at least one sub-text, the tag field matching the sub-text in semantics, and labeling the sub-text according to the tag field matching the sub-text in semantics to obtain a labeling result of the sub-text, wherein the labeling result characterizes the content structure; and
generating the labeling information according to each of the at least one sub-text and the labeling result corresponding to each of the at least one sub-text.

15. A non-transitory computer-readable medium, having a computer program stored thereon, wherein the computer program, when executed by a processing apparatus, is configured to perform a text content generation method, comprising:
displaying an information configuration interface, wherein the information configuration interface is configured to configure an attribute value of a preset attribute field of a to-be-recommended object; and
generating, in response to a triggered generation operation, target text content based on the attribute value configured in the information configuration interface, wherein the target text content is used for live streaming, the target text content comprises a tag field and text content corresponding to the tag field, and the tag field is used to characterize a content structure of the target text content.

16. The medium according to claim 15, wherein the to-be-recommended object comprises an object that acquires an attribute value through a preset interface, the information configuration interface comprises a first information configuration interface, the first information configuration interface is further configured to configure the to-be-recommended object, and
wherein the method further comprises:
acquiring, in response to an object selection operation triggered for the first information configuration interface, an attribute value of a preset attribute field of a to-be-recommended object corresponding to the object selection operation through the preset interface; and
automatically filling, according to the attribute value, the attribute value corresponding to the preset attribute field in the first information configuration interface.

17. The medium according to claim 15, wherein the to-be-recommended object comprises an object that acquires an attribute value based on an input operation of a user, the information configuration interface comprises a second information configuration interface, and
wherein the method further comprises:
displaying, in response to an input operation triggered for a preset attribute field in the second information configuration interface, input data corresponding to the input operation in the second information configuration interface, wherein the input data is used to characterize the attribute value of the preset attribute field.

18. The medium according to claim 15, wherein the preset attribute field comprises an attribute field that provides a candidate attribute value, and after the attribute value of the preset attribute field of the to-be-recommended object is configured, the method further comprises:
displaying, in the information configuration interface, at least one target control, wherein each of the at least one target control corresponds to one candidate attribute value corresponding to the preset attribute field, and the candidate attribute value is obtained through prediction based on information of the to-be-recommended object; and
using, in response to a trigger operation for the target control, a candidate attribute value corresponding to the target control as the attribute value of the preset attribute field.

19. The medium according to claim 15, wherein the generating, in response to a triggered generation operation, target text content based on the attribute value configured in the information configuration interface comprises:
generating, in response to the triggered generation operation, target text content corresponding to each content generation model of different content generation models by using the different content generation models based on the attribute value configured in the information configuration interface.

20. The medium according to claim 15, wherein after the target text content is generated, the method further comprises:
displaying prompt information in response to a modification operation for the attribute value, wherein the prompt information is used to prompt whether to re-generate the target text content.
